(19) United States
(12) Patent Application Publication
(10) Pub. No.: US 2026/0310046 A1
(43) Pub. Date: Oct. 8, 2026

(54) OPTICAL DEVICE AND IMAGE PICKUP SYSTEM

(71) Applicant: CANON KABUSHIKI KAISHA, Tokyo (JP)

(72) Inventor: WATARU NAKAYAMA, Tochigi (JP)

(21) Appl. No.: 19/554,763

(22) Filed: Mar. 3, 2026

(30) Foreign Application Priority Data
Apr. 2, 2025 (JP) 2025-061114

(51) Int. Cl. G03B 5/04; G02B 27/64

(52) U.S. Cl. CPC G03B 5/04; G02B 27/646; G03B 2205/0015

(57) ABSTRACT

An optical device includes a movable member, movable in a direction including a component perpendicular to an optical axis, that supports an optical element; a fixed member that supports the movable member; first and second driving units that move the movable member in directions different from each other; and a flexible substrate connected to the first and second driving units. The flexible substrate includes first and second curved parts connecting the movable member and the fixed member. When viewed from an optical axis direction, the first and second curved parts are arranged inside a circle centered on the optical axis and circumscribing the first and second driving units, and a midpoint between points of action of first and second reaction forces generated at the first and second curved parts, respectively, is located inside a triangle connecting the optical axis and centers of the first and second driving units.

### BACKGROUND

### Field of the Technology

The present disclosure relates to an optical device and an image pickup system.

### Description of the Related Art

For example, Japanese Patent Laid-Open No. 2015-75658 discloses an image stabilization apparatus in which two flexible substrates are arranged such that at least a portion of a reaction force generated by elastic deformation between the flexible substrates is canceled.

Additionally, Japanese Patent No. 4317537 discloses a configuration in which an electronic array optical sensor is driven in translation by a linear motor to compensate for image blur. By arranging flexible printed substrates symmetrically about the center of mass of a movable assembly, rotation of the movable assembly is suppressed.

### SUMMARY

According to an aspect of the present disclosure, an optical device comprises: a movable member configured to support an optical element and to be movable in a direction including a component perpendicular to an optical axis; a fixed member configured to support the movable member; first and second driving units configured to move the movable member in directions different from each other; and a flexible substrate connected to the first and second driving units. The flexible substrate includes first and second curved parts connecting the movable member and the fixed member. The first and second curved parts are arranged inside a circle that is centered on the optical axis and circumscribes the first and second driving units when viewed from an optical axis direction. When viewed from the optical axis direction, a midpoint between a point of action of a first reaction force generated when the movable member moves at the first curved part and a point of action of a second reaction force generated when the movable member moves at the second curved part is located inside a triangle connecting the optical axis and respective centers of the first and second driving units.

Features of the present disclosure will become apparent from the following description of embodiments with reference to the attached drawings. The following description of embodiments is described by way of example.

According to the present disclosure, downsizing of an optical device becomes possible while suppressing position-detection errors of a movable member.

### BRIEF DESCRIPTION OF THE DRAWINGS

FIG. 1 is a side view illustrating a configuration of a camera system according to an embodiment of the present disclosure.

FIG. 2 is an exploded perspective view of an image stabilization unit shown in FIG. 1.

FIG. 3 is a view of the image stabilization unit shown in FIG. 1 as viewed from an object side.

FIG. 4 is a cross-sectional view of the image stabilization unit taken along line A-A shown in FIG. 3.

FIG. 5 is another view of the image stabilization unit shown in FIG. 1 as viewed from the object side.

FIG. 6 is a cross-sectional view of the image stabilization unit taken along line B-B shown in FIG. 3.

FIG. 7 is a diagram for explaining a case in which a movable member moves.

### DESCRIPTION OF THE EMBODIMENTS

Hereinafter, embodiments of the present disclosure will be explained with reference to the drawings. However, the present disclosure is not limited to the following embodiments. Note that in each drawing, the same reference numerals are assigned to the same members or elements, and redundant explanation will be omitted or simplified.

The present disclosure is directed to enable downsizing of an optical device while suppressing position-detection errors of a movable member provided with an optical element.

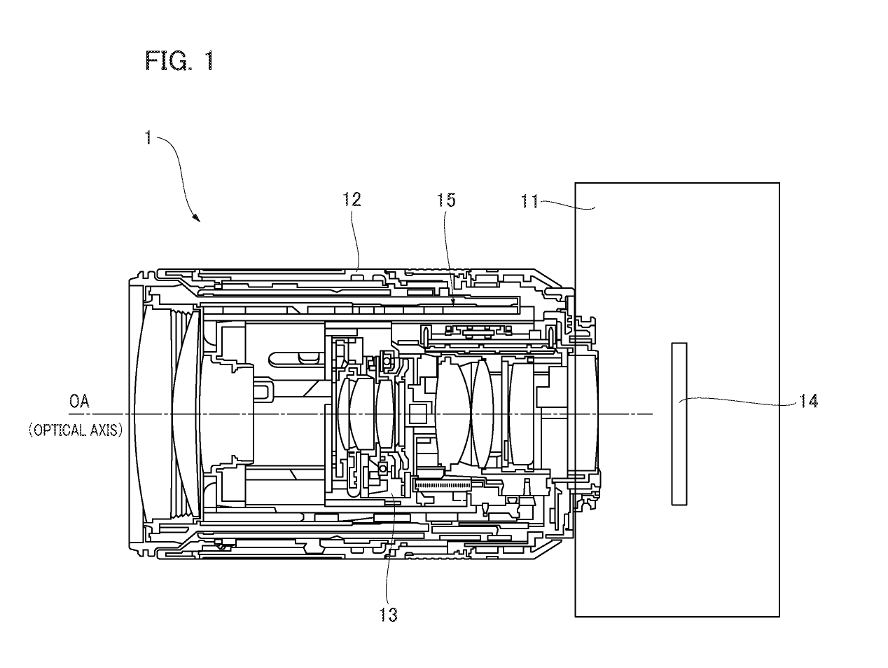

FIG. 1 illustrates a configuration of a camera system 1 serving as an image pickup system according to an embodiment of the present disclosure. The camera system 1 is configured by an image pickup unit 11 serving as an image pickup apparatus and a lens apparatus 12 attachable to and detachable from the image pickup unit 11. Note that the image pickup unit 11 and the lens apparatus 12 may be integrated.

The image pickup unit 11 generates an image signal by photoelectrically converting (imaging) an object image formed by an imaging optical system housed in a lens barrel 15 of the lens apparatus 12, using an image pickup device 14 configured by a CCD sensor or a CMOS sensor, and the like. That is, the image pickup unit 11 picks up an image of an object via an optical device. In the lens apparatus 12, an image stabilization unit 13 serving as an optical image stabilization device, which will be described below, is housed in the lens barrel 15. That is, the lens apparatus 12 functions as the optical device. Additionally, the imaging optical system has an optical axis OA extending toward an object side and an image side. In the following explanation, a direction in which the optical axis OA extends is referred to as an “optical axis direction”.

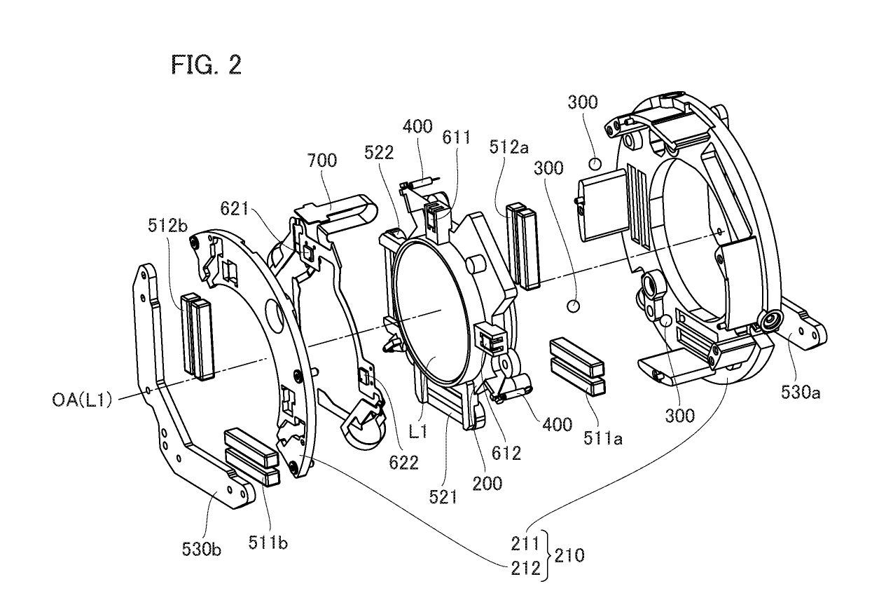

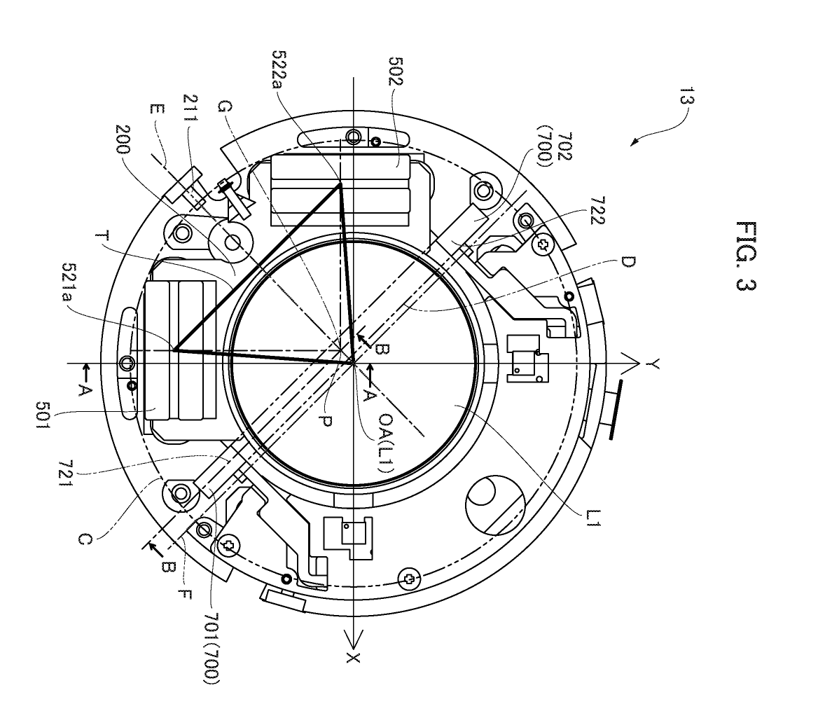

FIG. 2 is an exploded perspective view of the image stabilization unit 13 as viewed obliquely. FIG. 3 illustrates the image stabilization unit 13 as viewed from the object side.

The image stabilization unit 13 corrects image blur associated with camera shake, such as hand shake detected by a shake sensor (not illustrated), for example, an angular velocity sensor, by moving a correction lens L1 serving as an image stabilization lens (optical element) in a movement plane intersecting the optical axis OA (that is, orthogonal to the optical axis OA). Although the image stabilization unit 13 may have a configuration in which image blurring of an object image is corrected by moving the image stabilization lens in a plane orthogonal to an optical axis of the image stabilization lens, other configurations may be employed. It should be noted that although the present embodiment explains an image stabilization lens (lens) serving as an optical element, a configuration in which an optical element such as an optical filter or a diaphragm is moved may be employed.

The image stabilization unit 13 includes a fixed member 210 and a movable member 200 that supports the correction lens L1 and is movable relative to the fixed member 210. The fixed member 210 includes a base member 211 and a cover member 212 arranged on an object side, with the movable member 200 being interposed between the base member 211 and the cover member 212.

The correction lens L1 is supported by the movable member 200 and has an optical axis OA (L1). That is, the movable member 200 includes an image stabilization lens. Additionally, the optical axis OA (L1) indicates an optical axis passing through a central axis of the correction lens L1.

The movable member 200 is supported by the fixed member 210 so as to be movable within the movement plane via three rolling balls 300 arranged at three respective locations. Additionally, the movable member 200 is biased in the optical axis direction relative to the fixed member 210 by tension springs 400 arranged at two respective locations. Accordingly, the movable member 200 is pressed against the fixed member 210 via the rolling balls 300, is positioned in the optical axis direction, and is supported so as to be movable within the movement plane. That is, the movable member 200 supports the optical element and is movable in a direction including a component perpendicular to the optical axis.

It should be noted that, although in the present embodiment the movable member 200 is supported by three rolling balls 300 and two tension springs 400, the number of rolling balls 300 is not limited to three and the number of tension springs 400 is not limited to two, provided that the movable member 200 is supported so as to be movable within the movement plane.

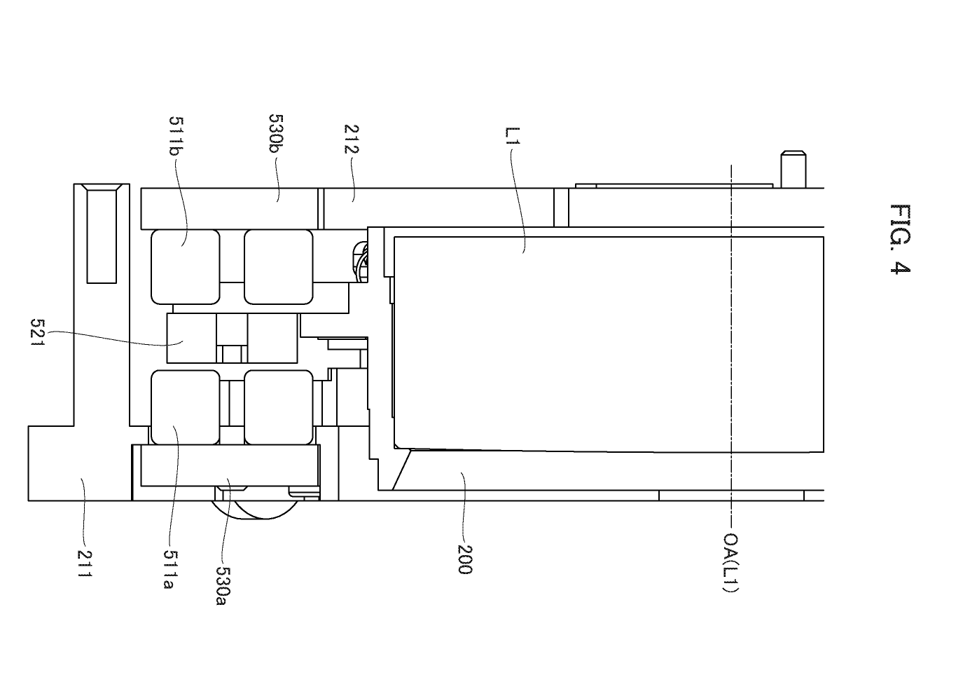

Next, a configuration of a driving unit for moving the movable member 200 will be explained. As illustrated in FIG. 3, the image stabilization unit 13 includes two actuators 501 and 502 serving as voice coil motors (hereinafter, referred to as “VCMs”) that drive the movable member 200. As illustrated in a cross-sectional view of FIG. 4, the actuator 501 is configured by a coil 521, two drive magnets 511a and 511b, and two yokes 530a and 530b.

The coil 521 is supported, for example, at a lower portion of the movable member 200. The drive magnet 511a is supported by the base member 211 at a position facing the coil 521 in an optical axis direction. The yoke 530a is formed in a plate shape from a ferromagnetic material such as iron, and is supported by the base member 211 so as to be adjacent to a surface of the drive magnet 511a on a side opposite to the coil 521.

The drive magnet 511b, which is the other drive magnet, is supported by the cover member 212 so as to face the coil 521. The yoke 530b is supported by the cover member 212 so as to be adjacent to a surface of the drive magnet 511b on a side opposite to the coil 521.

The actuator 502 is configured by a coil 522, two drive magnets 512a and 512b, and two yokes 530a and 530b (see FIG. 2). The coil 522 is supported, for example, at a left-side portion of the movable member 200. The drive magnets 512a and 512b are supported, for example, at a left-side portion of the base member 211. A positional relationship between the coil 522, the two drive magnets 512a and 512b, and the two yokes 530a and 530b is similar to that of the actuator 501.

Although in the present embodiment, each VCM is configured such that the coil 521 (522) is disposed between the drive magnets 511a and 511b (512a and 512b) in an optical axis direction, a positional relationship in the optical axis direction between the base member 211 and the cover member 212, which constitute the fixed member 210, may be reversed. Additionally, the drive magnet of each VCM may be provided on only one side.

The actuator 501 generates a driving force for driving the movable member 200 in the Y-axis direction in FIG. 3 by energizing the coil 521. The actuator 502 generates a driving force for driving the movable member 200 in the X-axis direction in FIG. 3 by energizing the coil 522. By controlling the driving forces generated by the actuators 501 and 502, the movable member 200 can be driven to an arbitrary position within the movement plane. That is, the actuators 501 and 502 respectively function as first and second driving units for moving the movable member in mutually different directions. Furthermore, the coil 521 constituting the actuator 501 functions as a third driving unit, and the drive magnets 511a and 511b function as a fourth driving unit. Furthermore, the coil 522 constituting the actuator 502 functions as a fifth driving unit, and the drive magnets 512a and 512b function as a sixth driving unit.

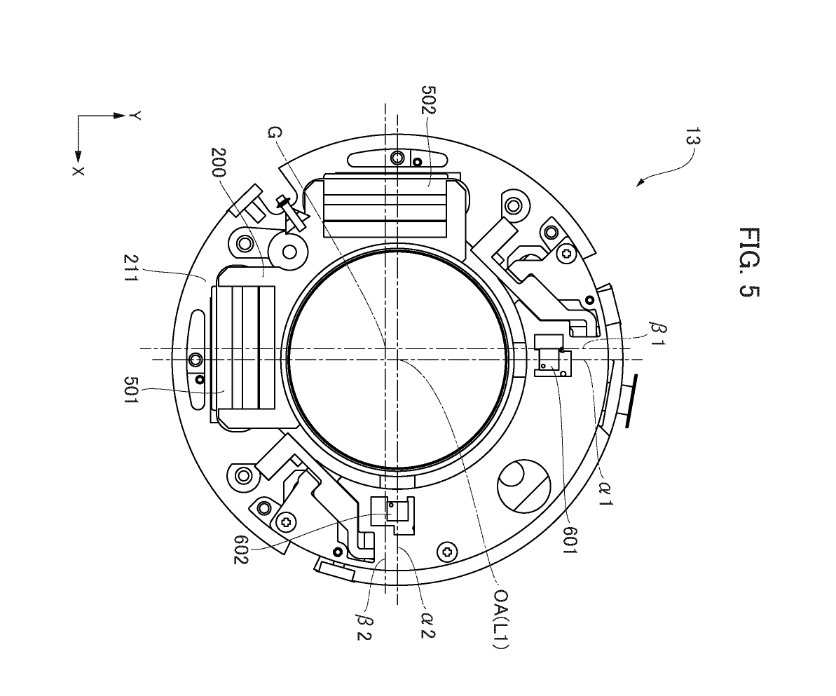

As illustrated in FIG. 5, the actuator 501 has a drive center axis β1 that passes through a driving force generation center thereof and extends in a drive force generation direction (a Y-axis direction, which is a first drive direction) parallel to the movement plane. The actuator 502 has a drive center axis β2 that passes through a drive force generation center thereof and extends in a drive force generation direction (an X-axis direction, which is a second driving direction) parallel to the movement plane. The drive force generation center of the actuator 501 referred to herein is, for example, the center of the drive magnets 511a and 511b as viewed from the optical axis direction, and similarly, the driving force generation center of the actuator 502 is a center of the drive magnet 512 as viewed from the optical axis direction.

Note that in the present embodiment, each of the actuators 501 and 502 is a VCM (voice coil motor), and a driving force acts in a direction orthogonal to a longitudinal direction of the coils 521 and 522. Although a case has been described in which the drive center axis β1 and the drive center axis β2 are parallel to the Y-axis and the X-axis, respectively, the drive center axis β1 is not required to be parallel to the Y-axis, and the drive center axis β2 is not required to be parallel to the X-axis.

Next, a configuration of a position detection unit for controlling a position of the movable member 200 will be described. The image stabilization unit 13 is provided with a position sensor 601 serving as a first position detection unit and a position sensor 602 serving as a second position detection unit (see FIG. 5). The position sensor 601 is configured by a magnetic sensor 621, such as a Hall element, and a detection magnet 611 (see FIG. 2). The magnetic sensor 621 is mounted on a flexible printed substrate (FPC) 700, which will be described below, and is fixed to the fixed member 210. The detection magnet 611 is fixed to a portion of the movable member 200 facing the magnetic sensor 621.

Additionally, similarly to the position sensor 601, the position sensor 602 is configured by a magnetic sensor 622, such as a Hall element, and a detection magnet 612 (see FIG. 2). The magnetic sensor 622 is mounted on the flexible printed substrate 700 and fixed to the fixed member 210. The detection magnet 612 is fixed to a portion of the movable member 200 facing the magnetic sensor 622. Additionally, the position sensor 602 is arranged at a position different from that of the position sensor 601. Although in FIG. 5 the detection center axis α1 of the position sensor 601 and the detection center axis α2 of the position sensor 602 are arranged so as to be orthogonal to each other, the present disclosure is not limited to this arrangement.

Note that in the present embodiment, the magnetic sensors 621 and 622 are arranged on the cover member 212, although the magnetic sensors 621 and 622 may be arranged on the base member 211. Alternatively, the detection magnets 611 and 612 may be arranged on the fixed member 210, while the magnetic sensors 621 and 622 may be arranged on the movable member 200.

Next, a flexible printed circuit (also referred to as a flexible substrate; hereinafter referred to as an “FPC”) 700 for energizing the coils 521 and 522 constituting the VCMs explained with reference to FIG. 3 and the like will be explained. The FPC 700 has a portion fixed to the movable member 200 and a portion fixed to the fixed member 210 and includes movable parts 701 and 702 (to be described below) as portions that connect these portions to each other. The FPC 700 branches into two and is fixed to the movable member 200 to energize the two coils arranged on the movable member 200 and includes the movable parts 701 and 702 so that energization is maintained even when the movable member 200 moves. In the present embodiment, among the first and second driving units, the third and fifth driving units are arranged on the movable member 200 and are each energized via the flexible substrate. That is, the flexible substrate is connected to the first and second driving units.

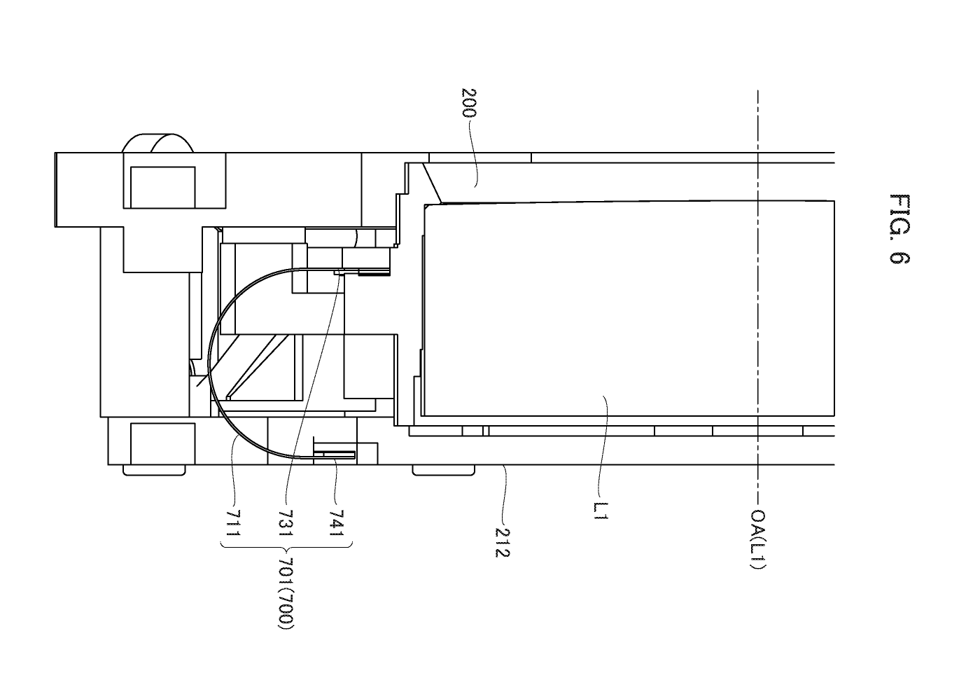

As shown in FIG. 6, the movable part 701 includes a movable-side connection part 731 connected to the movable member 200, a fixed-side connection part 741 fixed to the fixed member 210, and a curved part 711 that connects the movable-side connection part 731 and the fixed-side connection part 741. That is, the movable part 701 functions as a first movable part having a first curved part that connects the movable member 200 and the fixed member 210.

In the movable part 701, the FPC 700 is folded back in the optical axis direction, and the movable-side connection part 731 and the fixed-side connection part 741 are spaced apart from each other along the optical axis direction. The curved part 711 deforms due to flexibility of the FPC 700 as the movable member 200 moves. When the curved part 711 deforms, a reaction force is generated against the movable member 200 at a reaction force acting part 721 (see FIG. 3) so as to return the curved part 711 to an original shape of the curved part 711. The reaction force acting part 721 is the entire movable-side connection part 731 or a portion included in the movable-side connection part 731. That is, the reaction force acting part 721 corresponds to a point of action of a first reaction force generated when the movable member 200 moves.

Similarly to the movable part 701, the movable part 702 includes a movable-side connection part, a fixed-side connection part, and a curved part, and when the movable member 200 moves, a reaction force is also generated against the movable member 200 at a reaction force acting part 722 (see FIG. 3). That is, the movable part 702 functions as a second movable part having a second curved part that connects the movable member 200 and the fixed member 210. Additionally, the reaction force acting part 722 corresponds to a point of action of a second reaction force generated when the movable member 200 moves.

As shown in FIG. 3, in the present embodiment, a midpoint between the reaction force acting part 721 and the reaction force acting part 722 is first defined as P. The FPC 700 is then arranged such that, when viewed from the optical axis direction, the midpoint P is located inside a virtual triangle T connecting the optical axis OA (L1), a coil winding center 521a of the coil 521, and a coil winding center 522a of the coil 522. Here, the coil winding center 521a corresponds to the center of the first driving unit, and the coil winding center 522a corresponds to the center of the second driving unit.

The FPC 700 may be arranged such that, when viewed from the optical axis direction, at least a part of the reaction force acting part 721 overlaps the reaction force acting part 722 when the reaction force acting part 721 is rotated by 180° about a center of gravity G of the movable member 200. Furthermore, the movable part 701 and the movable part 702 may be arranged so as to be substantially point-symmetric with respect to the center of gravity G of the movable member 200.

Additionally, the movable part 701 and the movable part 702 of the FPC 700 may be arranged so as to be substantially symmetrical with respect to a virtual straight line E (see FIG. 3) that passes through the optical axis OA (L1) and a midpoint between the two coil winding centers 521a and 522a, when viewed from the optical axis direction. This corresponds to the flexible substrate being arranged such that the reaction force acting part 721 and the reaction force acting part 722 are substantially symmetrical with respect to a straight line connecting the optical axis and a midpoint between a center of the first driving unit and a center of the second driving unit, when viewed from the optical axis direction.

Furthermore, the curved part 711 of the movable part 701 and the curved part of the movable part 702 are arranged such that convex directions of curvature thereof are opposite to each other. In other words, a concave direction of the curved part 711 of the movable part 701 and a concave direction of the curved part of the movable part 702 face each other. At this time, as shown in FIG. 3, at least a part of a virtual extension region D, obtained by virtually extending the concave direction of the curved part 711 toward the movable part 702 by a width of the movable part 701, may overlap the reaction force acting part 722. When viewed from the optical axis direction, the virtual extension region D may overlap a center of gravity G of the movable member 200. That is, the virtual extension region D corresponds to a virtual straight line connecting a direction in which the curved part of the first movable part faces and a direction in which the curved part of the second movable part faces, and this corresponds to the movable parts 701 and 702 being arranged such that the virtual straight line passes through the center of gravity G.

One of the subjects to be solved in the present embodiment is that the movable member 200 unintentionally rotates due to a reaction force of the FPC 700. In a case in which the coils 521 and 522 are arranged on the movable member 200 in order to drive the correction lens L1 having large mass, generation of a reaction force from the FPC 700 is unavoidable. In contrast, if a rotation restricting member or the like is provided, the image stabilization unit 13 and the entire lens apparatus 12 increase in size. In a case in which no rotation restricting member or the like is provided, rotation of the movable member 200 causes a detection error in the position sensors 601 and 602, which leads to a reduction in image stabilization performance.

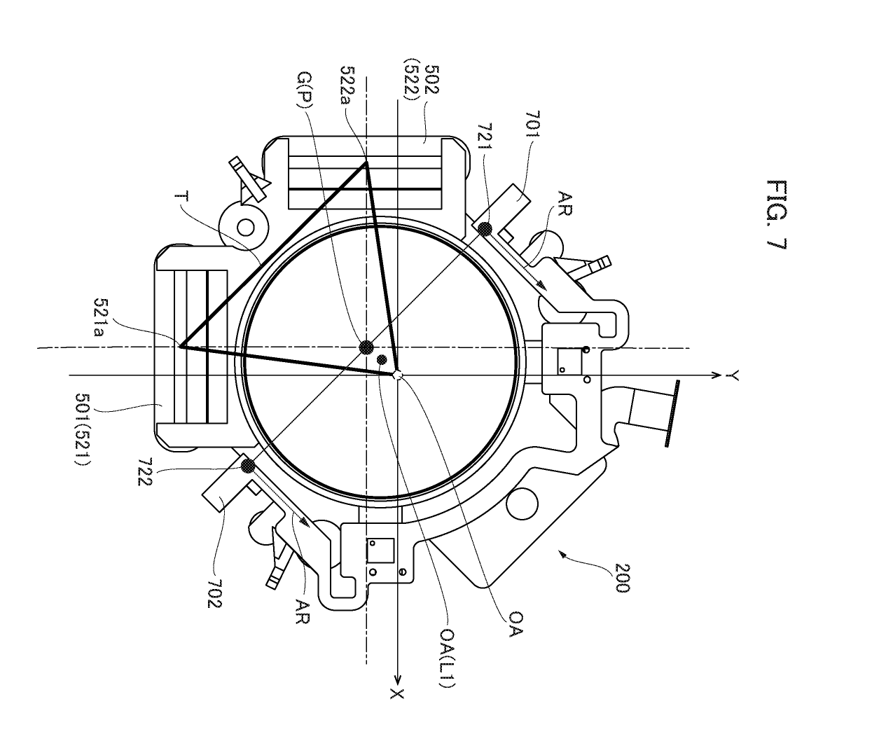

Next, effects obtained by the arrangement of the FPC 700 described above will be explained with reference to FIG. 7. First, a case in which the movable member 200 moves with respect to the fixed member 210 will be described. Reaction forces of the same magnitude in directions opposite to a moving direction (arrow AR) are generated at the reaction force acting part 721 and the reaction force acting part 722 according to an amount of movement.

Here, in a case in which the correction lens L1 is driven by the coils arranged on the movable member 200, constituent parts having large mass are the correction lens L1 and the two coils 521 and 522. At this time, a center of gravity G in a movement plane of the movable member 200 is located inside the triangle T defined by the optical axis OA (L1), the coil winding center 521a, and the coil winding center 522a. That is, by arranging the FPC 700 as described above, an arrangement is possible in which, when viewed from the optical axis direction, a distance between a midpoint P between the reaction force acting part 721 and the reaction force acting part 722 and the center of gravity G is reduced. Note that, although the midpoint P of the reaction force acting parts 721 and 722 overlaps the center of gravity G in FIG. 3 and FIG. 7, the midpoint P and the center of gravity G do not necessarily have to overlap, provided that the center of gravity G is located inside the triangle T.

At this time, since directions of rotational moments caused by reaction forces acting at the two locations are opposite to each other, in a case in which a distance between the reaction force acting part 721 and the center of gravity G and a distance between the reaction force acting part 722 and the center of gravity G are approximately equal, magnitudes of the rotational moments are also approximately equal and cancel each other. When viewed from the optical axis direction, when the two reaction force acting parts 721 and 722 are arranged substantially point-symmetrically with respect to the center of gravity G, the magnitudes of the rotational moments generated by the reaction forces may coincide with each other and directions thereof are opposite. Although the magnitudes of the rotational moments do not necessarily have to coincide perfectly, by arranging a midpoint of the reaction force acting parts to be located inside the triangle T as described above, rotation of the movable member 200 can be suppressed.

Even in a case in which the movable member 200 rotates about the optical axis OA (L1), reaction forces act on the reaction force acting part 721 and the reaction force acting part 722, similarly to a case of translational movement. At this time, since a moment generated by the reaction forces acts in a direction opposite to a rotation direction, even when the movable member 200 rotates due to a disturbance and the like, a reaction force is generated in a direction that suppresses the rotation.

Note that, although a case in which two reaction forces of the FPC 700 are equal has been described in the present embodiment, it is sufficient that rotational moments caused by the FPC 700 cancel each other. For example, in a case in which an arrangement in which distances between the two reaction force acting parts and the center of gravity G of the movable member 200 are close to each other is impossible, rotation can also be suppressed by providing a difference between the reaction forces. Specifically, an arrangement may be adopted in which a reaction force is stronger on a side closer to the center of gravity G and weaker on a side farther from the center of gravity G. As a method for varying the reaction forces, a difference may be provided in widths of portions constituting the movable parts 701 and 702 of the FPC 700. That is, one of the first curved part and the second curved part that is closer to the center of gravity G of the movable member 200 may have a greater width than the other. Alternatively, materials having different rigidities may be used for the portions constituting the movable parts 701 and 702. That is, one of the first curved part and the second curved part that is closer to the center of gravity G of the movable member 200 may have higher rigidity than the other.

Additionally, in the present embodiment, the movable part 701 and the movable part 702 are arranged inside a circle C (see FIG. 3) that is centered on the optical axis OA (L1) and circumscribes the actuator 501 and the actuator 502. That is, when viewed from the optical axis direction, the first curved part and the second curved part are arranged inside a circle that is centered on the optical axis and circumscribing the first driving unit and the second driving unit. In a case in which the present embodiment is applied to an optical device such as the lens apparatus 12, outer diameter constraints are significant. Therefore, by arranging the movable part 701 and the movable part 702 inside the circle C that circumscribes the actuators 501 and 502 about the optical axis OA (L1), the image stabilization unit 13 and the lens apparatus 12 can be downsized.

Additionally, in the present embodiment, the actuator 501 and the movable part 701 of the FPC 700 are arranged, for example, on a lower side in FIG. 3, and the actuator 502 and the movable part 702 of the FPC 700 are arranged, for example, on a left side in FIG. 3. Specifically, when the image stabilization unit 13 is divided into two regions by a straight line F that is centered on the optical axis OA (L1) and extends in a radial direction of the correction lens L1, the actuator 501 and the movable part 701 (or the actuator 502 and the movable part 702) are arranged on one side. That is, this straight-line F corresponds to a virtual straight line that passes through the optical axis and extends in a radial direction (planar direction) of an optical element. The first driving unit, the second driving unit, a point of action of a first reaction force, and a point of action of a second reaction force are arranged in one of two regions divided by the virtual straight-line F.

By arranging the components in this manner, downsizing of the product becomes possible by arranging other components and the like in a remaining region (space) in which components such as the actuator 501 are not arranged. For example, by arranging a drive motor for an adjacent diaphragm or the like, downsizing in the optical axis direction is possible, and by arranging a focus motor or the like, downsizing in a radial direction also becomes possible.

As described above, by adopting the configuration of the present embodiment, unintended rotation of the movable member 200 of the image stabilization unit 13 can be suppressed. Additionally, downsizing of the image stabilization unit 13 becomes possible. Therefore, the lens apparatus 12 can be downsized while suppressing position detection errors of the movable member 200.

Next, a configuration for suppressing performance degradation caused by rotation of the movable member 200 about the optical axis OA (L1) will be described.

In the present embodiment, the movable member 200 is driven by receiving forces in two directions from the actuator 501 and the actuator 502. At this time, forces generated by the VCM act in directions of a drive center axis β1 and a drive center axis β2 (see FIG. 5), and to suppress rotation, the drive center axes β1 and β2 may be located close to the center of gravity G.

Additionally, in the present embodiment, the actuators 501 and 502 are arranged such that, when viewed from the optical axis direction (see FIG. 5), the drive center axis β1 and the drive center axis β2 are located closer to the center of gravity G than to the optical axis OA (L1). The image stabilization unit 13 may be arranged such that the drive center axis β1 and the drive center axis β2 pass through the center of gravity G.

Additionally, although in the present embodiment, an example has been described in which the drive center axis β1 and the drive center axis β2 are orthogonal to each other, the two drive center axes β1 and β2 only need to extend in different directions and do not necessarily have to be orthogonal to each other.

Additionally, in the present embodiment, the position of the movable member 200 is detected by two position sensors 601 and 602. As described above, rotation of the movable member 200 may cause detection errors in the position sensors 601 and 602, resulting in performance degradation. Detection errors during rotation increase as a distance between the detection center axis α1 of the position sensor 601 and the optical axis OA (L1), and a distance between the detection center axis α2 of the position sensor 602 and the optical axis OA (L1), increase (see FIG. 5). By contrast, in the present embodiment, in order to suppress detection errors, the position sensors 601 and 602 are arranged such that the detection center axes α1 and α2 are located closer to the optical axis OA (L1) than to the center of gravity G.

Furthermore, the present disclosure is not limited to the movable parts 701 and 702, and the same applies to the plurality of tension springs 400. That is, the plurality of tension springs 400 may be arranged such that a combined load point of the tension springs 400 is located closer to the center of gravity G than to the optical axis OA (L1).

According to the present disclosure, downsizing of the optical device becomes possible while position-detection errors of the movable member are suppressed.

### Other Embodiments

As described above, although the present disclosure has been described in detail based on the embodiments thereof, the present disclosure is not limited to the above-described embodiments, and various modifications may be made based on the spirit of the present disclosure without departing from the scope of the present disclosure.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-061114, filed Apr. 2, 2025, which is hereby incorporated by reference herein in its entirety.

What is claimed is:

1. An optical device comprising:
a movable member configured to support an optical element and to be movable in a direction including a component perpendicular to an optical axis;
a fixed member configured to support the movable member;
first and second driving units configured to move the movable member in directions different from each other; and
a flexible substrate connected to the first and second driving units,
wherein the flexible substrate includes first and second curved parts connecting the movable member and the fixed member,
wherein the first and second curved parts are arranged inside a circle that is centered on the optical axis and circumscribes the first and second driving units when viewed from an optical axis direction, and
wherein, when viewed from the optical axis direction, a midpoint between a point of action of a first reaction force generated when the movable member moves at the first curved part and a point of action of a second reaction force generated when the movable member moves at the second curved part is located inside a triangle connecting the optical axis and respective centers of the first and second driving units.

2. The optical device according to claim 1, wherein the first curved part and the second curved part are arranged so as to face each other.

3. The optical device according to claim 2, wherein the first curved part and the second curved part are arranged such that a virtual straight line connecting a direction in which the first curved part faces and a direction in which the second curved part faces passes through the center of gravity of the movable member.

4. The optical device according to claim 1, wherein when the point of action of the first reaction force is rotated 180° about the center of gravity of the movable member as viewed from the optical axis direction, at least a part of the point of action of the first reaction force overlaps the point of action of the second reaction force.

5. The optical device according to claim 1, wherein the first driving unit, the second driving unit, the point of action of the first reaction force, and the point of action of the second reaction force are arranged in one of two regions divided by a virtual straight line that passes through the optical axis and extends in a radial direction of the optical element.

6. The optical device according to claim 1, wherein one of the first curved part and the second curved part that is closer to the center of gravity of the movable member is formed to be wider than the other.

7. The optical device according to claim 1, wherein one of the first curved part and the second curved part that is closer to the center of gravity of the movable member is formed to have higher rigidity than the other.

8. The optical device according to claim 1, wherein the first and second driving units are arranged such that a drive center axis of the first driving unit and a drive center axis of the second driving unit are each closer to the center of gravity of the movable member than to the optical axis of the optical element.

9. The optical device according to claim 1, further comprising first and second position detection units configured to detect a position of the movable member relative to the fixed member,
wherein the first and second position detection units are arranged such that a detection center axis of the first position detection unit and a detection center axis of the second position detection unit are closer to the optical axis of the optical element than to the center of gravity of the movable member.

10. The optical device according to claim 1, wherein the movable member is biased toward the fixed member by a plurality of springs.

11. The optical device according to claim 10, wherein a combined load point of the plurality of springs is closer to the center of gravity of the movable member than to the optical axis of the optical element.

12. An optical device comprising:
a movable member configured to support an optical element and to be movable in a direction including a component perpendicular to an optical axis;
a fixed member configured to support the movable member;
first and second driving units configured to move the movable member in directions different from each other; and
a flexible substrate connected to the first and second driving units,
wherein the flexible substrate includes first and second curved parts connecting the movable member and the fixed member, and
wherein the flexible substrate is arranged such that, when viewed from an optical axis direction, a point of action of a first reaction force generated when the movable member moves at the first curved part and a point of action of a second reaction force generated when the movable member moves at the second curved part are substantially symmetrical with respect to a straight line connecting the optical axis and respective centers of the first and second driving units.

13. The optical device according to claim 1, wherein the optical device is attachable to and removable from an image pickup apparatus.

14. The optical device according to claim 12, wherein the optical device is attachable to and removable from an image pickup apparatus.

15. An image pickup system comprising:
the optical device according to claim 1; and
an image pickup apparatus configured to pick up an image of an object through the optical device.

16. An image pickup system comprising:
the optical device according to claim 12; and
an image pickup apparatus configured to pick up an image of an object through the optical device.
